(19) United States
(12) Patent Application Publication
(10) Pub. No.: US 2022/0390758 A1
(43) Pub. Date: Dec. 8, 2022

(54) ELECTRONIC DIFFRACTION DIAPHRAGM

(71) Applicant: Natalya VORONINA, Teykovo (RU)

(72) Inventor: Natalya VORONINA, Teykovo (RU)

(21) Appl. No.: 17/800,704

(22) PCT Filed: Apr. 13, 2021
(86) PCT No.: PCT/RU2021/050097

§ 371 Date: Aug. 18, 2022

(30) Foreign Application Priority Data
Feb. 20, 2020 (RU) 2020107827

(51) Int. Cl. G02B 27/42; G02F 1/01; G03B 9/02

(52) U.S. Cl. CPC G02B 27/4205; G02F 1/0102; G03B 9/02

(57) ABSTRACT

The invention relates to optical instruments, more specifically to electronic diffraction diaphragms, controllable light-adjusting elements and optical filters for objectives, cameras and other optical devices. A device has been developed for adjusting optical devices and changing the intensity, direction and concentration of light rays in optical instruments by creating, in real time or a specified time, variable diffraction stencil patterns (plane-parallel and perpendicular bands, concentric circles and other shapes) on an element of an electronic diaphragm. The electronic diffraction diaphragm device can operate both in a dynamic and in a static operation mode of the element. A device of this kind enhances the capabilities of other optical instruments and cameras and improves or changes the characteristics thereof.

### FIELD OF THE INVENTION

The present invention relates to optical diaphragms and light filters, modular stencil correctors of the luminous flux for optical devices and devices according to the claims of the invention.

### SUMMARY OF THE INVENTION

The patent document discloses the device and the principle of operation of an electronically controlled diffraction-diaphragming element (ECDDE), in which it is possible to change the light transmission and the direction of movement of light streams when passing through the plane of the element (transparent or reflective partition) when it occurs on it diffraction stencil shapes and patterns (according to the text —Stencil). In fact, the ECDDE is based on a matrix optically changeable element. In the absence of a control voltage, the element becomes transparent (for mirror devices in the non-working state, it can be opaque or reflective).

The present invention is based on the task of combining an electronically controlled diaphragm, a light filter and an optical corrector in one device that provides a fast response, the ability to change optical properties in real or preset time, as well as increased usability. Device it is proposed for embedding it in both new and existing lenses, optical devices, apparatuses and systems based on them in order to expand and change their characteristics.

The possibility of partial or full light transmission, control of the intensity of the luminous flux is realized (brightness, contrast, tone, etc.), changes in the direction of light movement, changes in the color of the areas of the luminous flux (formed image), changes in focus and depth of field of the depicted lens space, correction of several listed parameters of the optical device at once.

### BRIEF DESCRIPTION OF INVENTION

For a fuller understanding of the invention, reference should be made to the following detailed description, taken in connection with the accompanying drawings, in which:

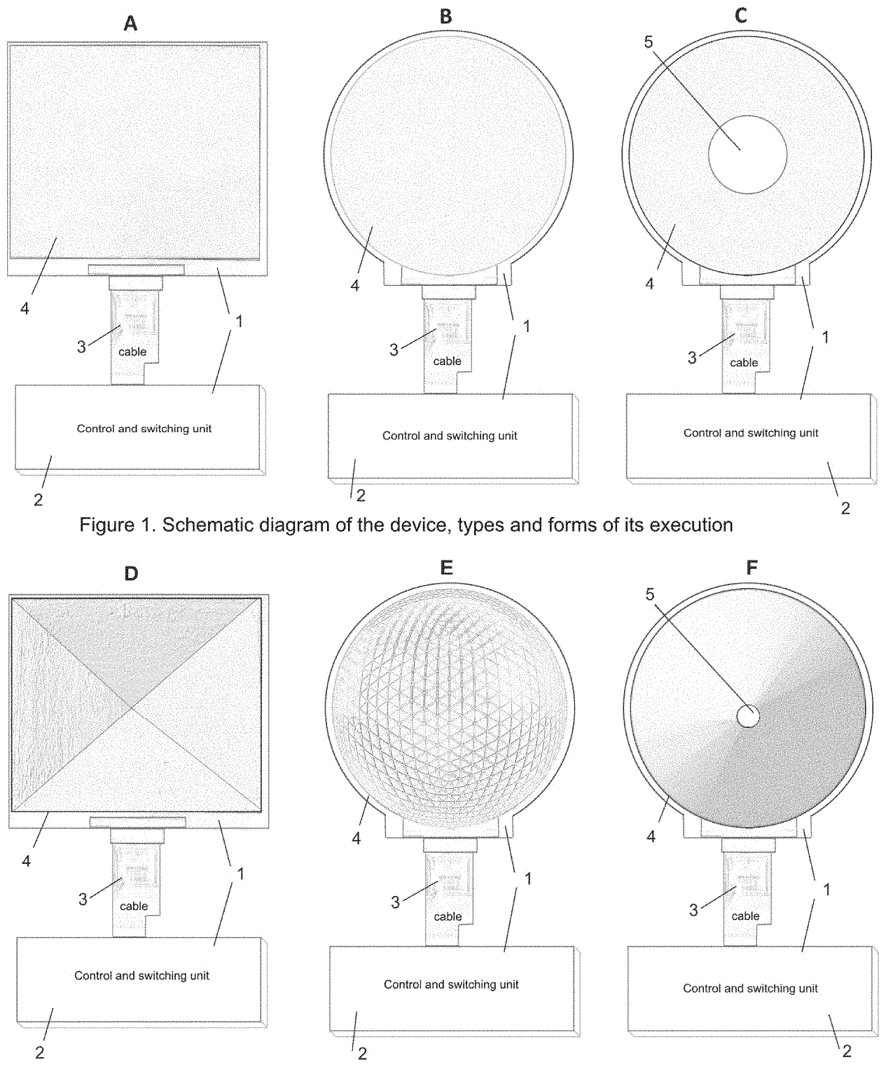

FIG. 1 illustrates implementation of an electronically controlled diffraction-diaphragming element (ECDDE), as an embodiment of the present invention.

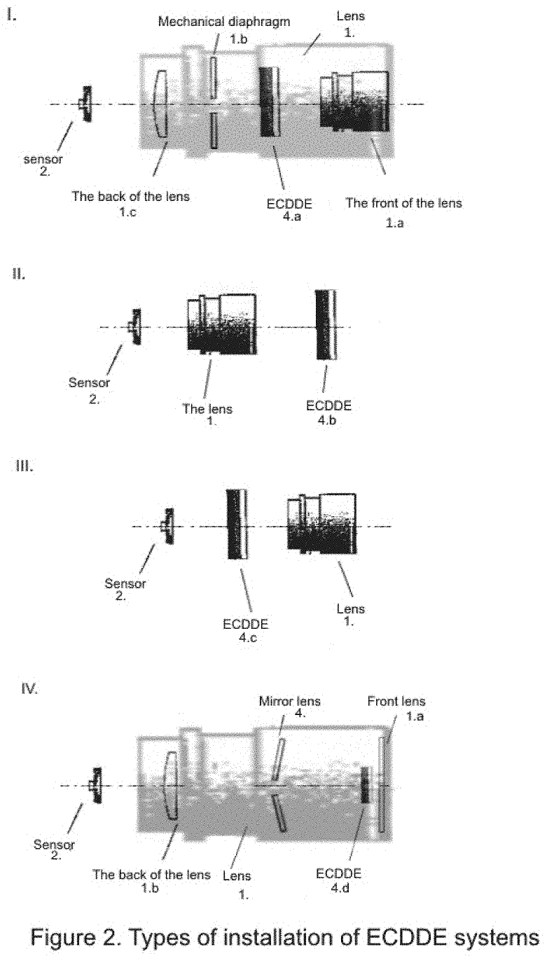

FIG. 2 illustrates implementation of ECDDE installed in an optical system consisting of a photosensitive element, as an embodiment of the present invention.

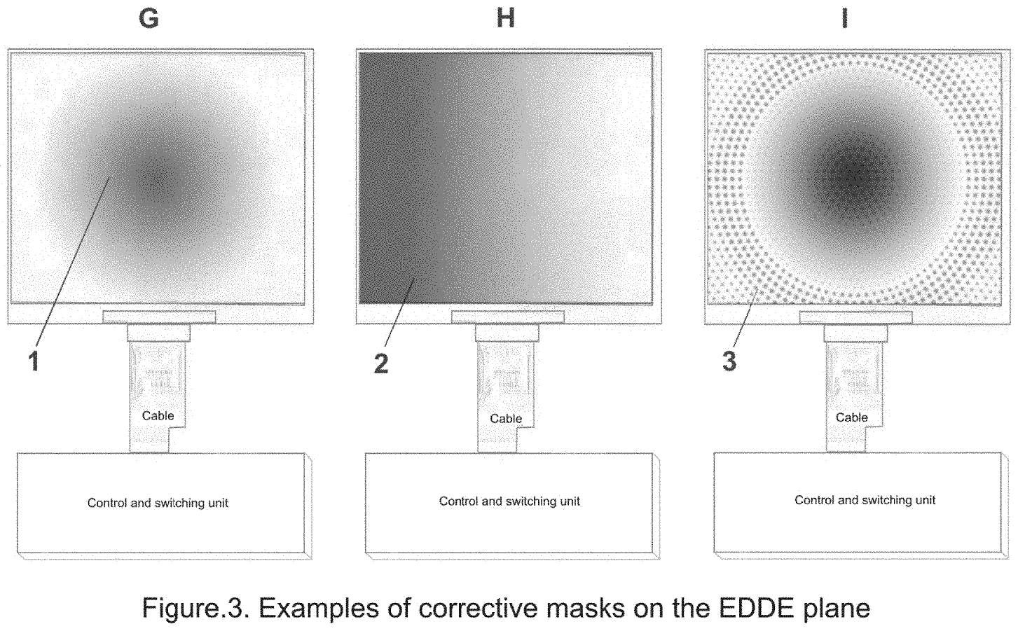

FIG. 3 illustrates implementation of the possible types of corrective stencil templates, as an embodiment of the present invention.

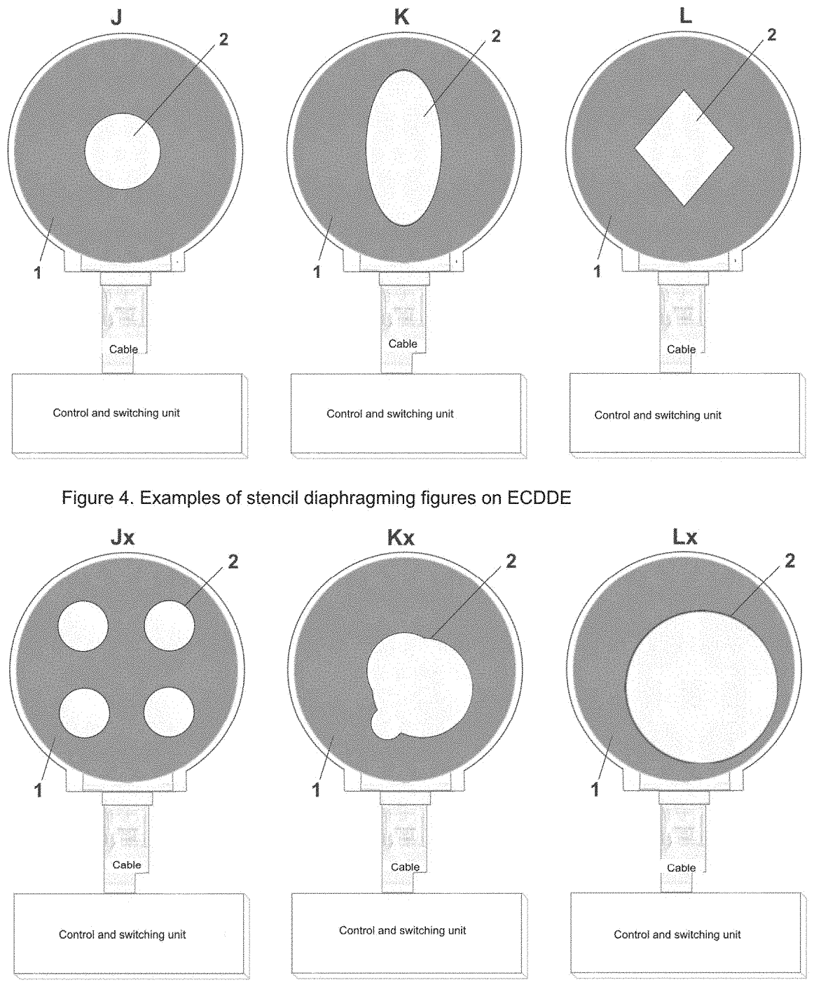

FIG. 4 illustrates implementation of the use of the ECDDE device as an electronically controlled diffraction diaphragm of various shapes, as an embodiment of the present invention.

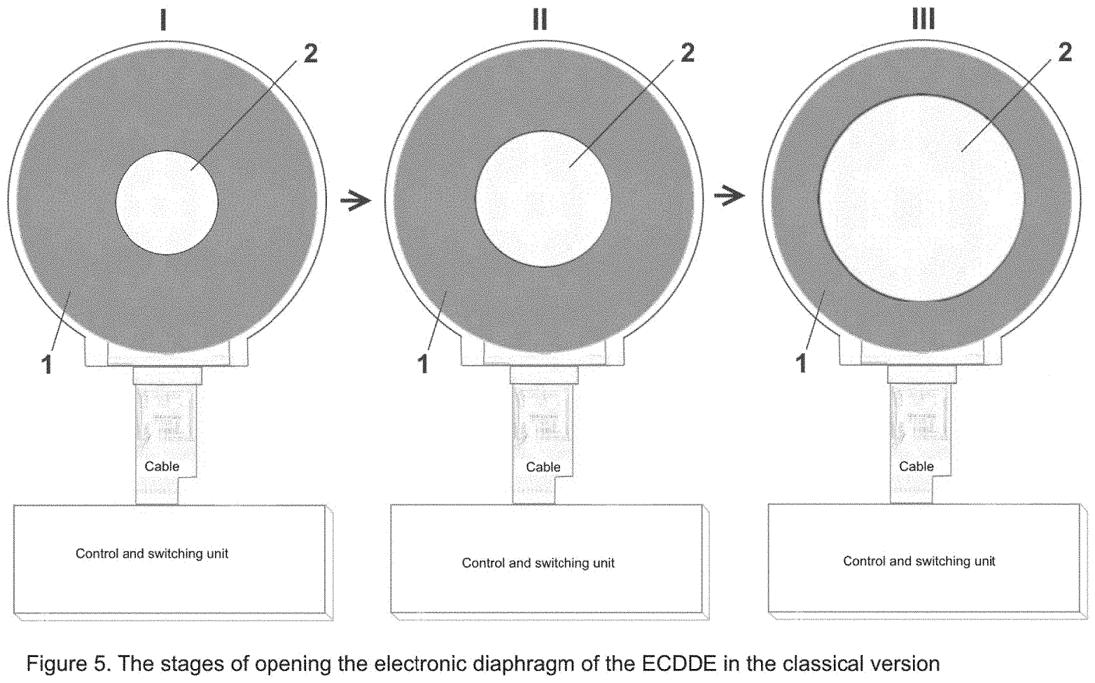

FIG. 5 illustrates implementation of the classical stages of the stepwise opening of the circular diaphragm on the ECDDE element, as an embodiment of the present invention.

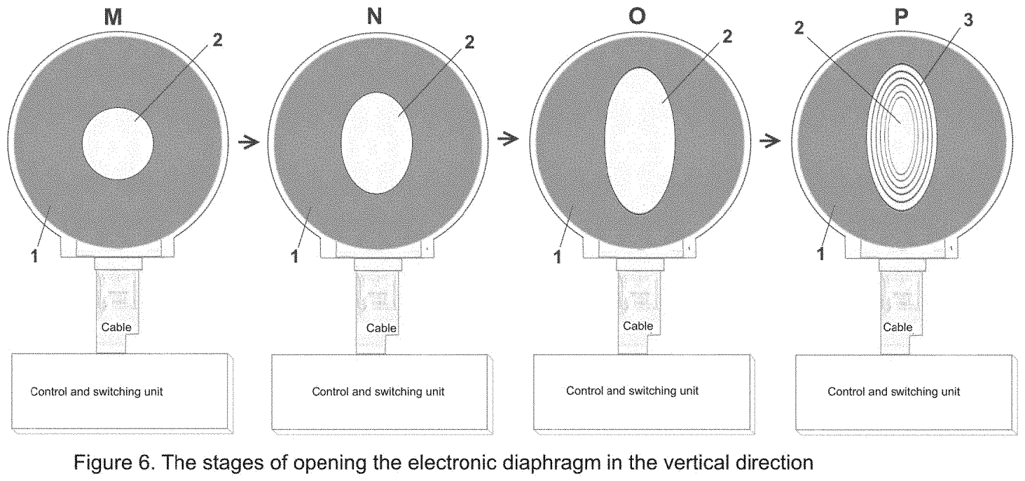

FIG. 6 illustrates implementation of special example of ECDDE is an uneven opening of the electronic diaphragm, as an embodiment of the present invention.

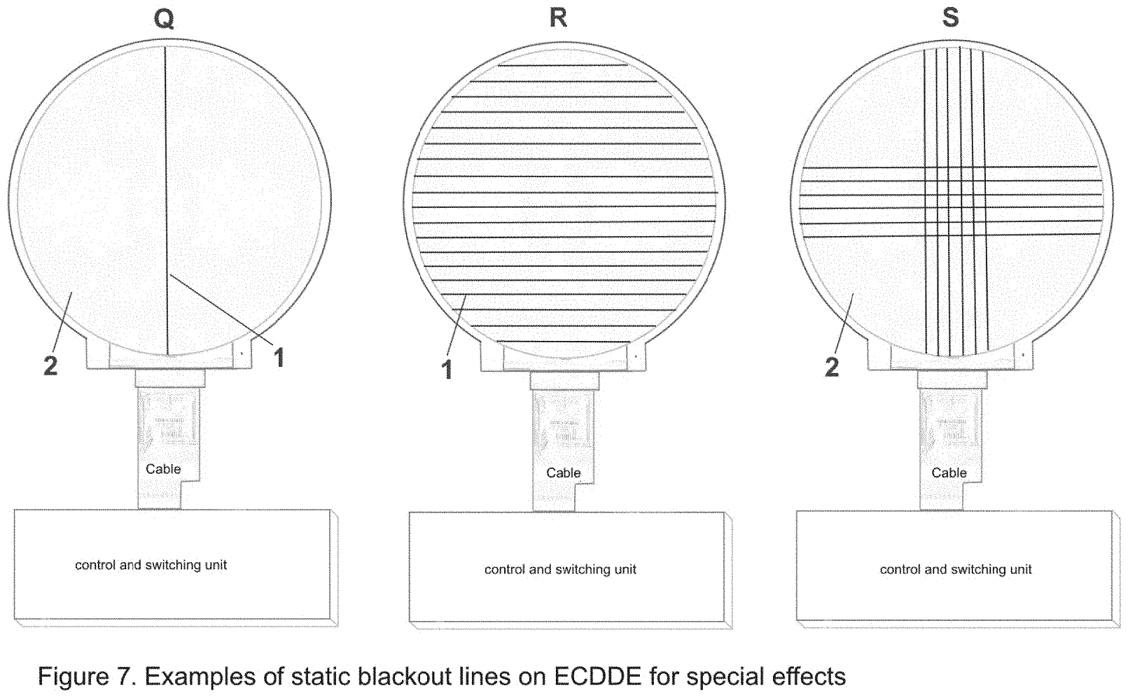

FIG. 7 illustrates implementation of the use of ECDDE as artistic light filters mainly in dynamic, artistic, preset and combined modes of operation, having radial (star (pos. S), striped (pos. R)), annular (radial), and other stencil lines (11), as an embodiment of the present invention.

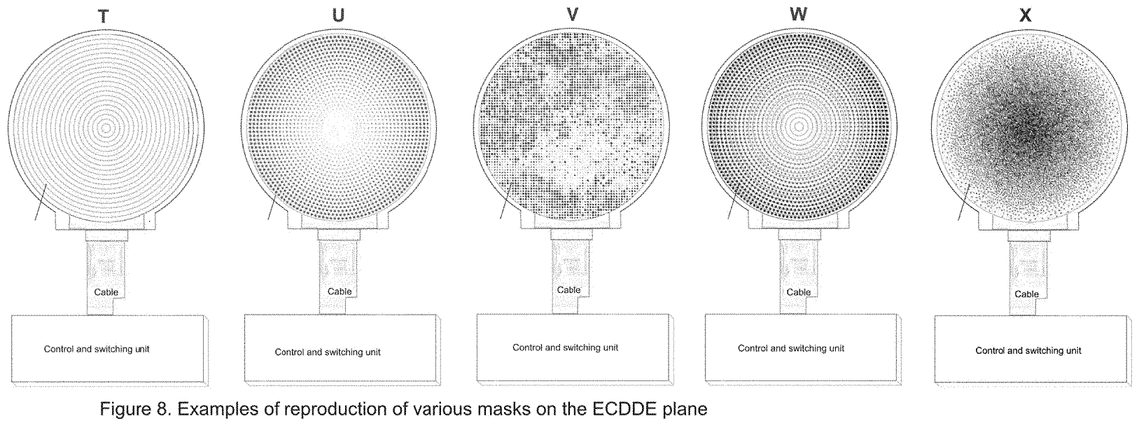

FIG. 8 illustrates implementation of Formation of diffusion (pos. X), diffraction-radial (pos. T) and diffraction-point (pos. U), foggy (pos. V), combined (pos. W) and complex interference light filtering stencils, both monochrome and color, as an embodiment of the present invention.

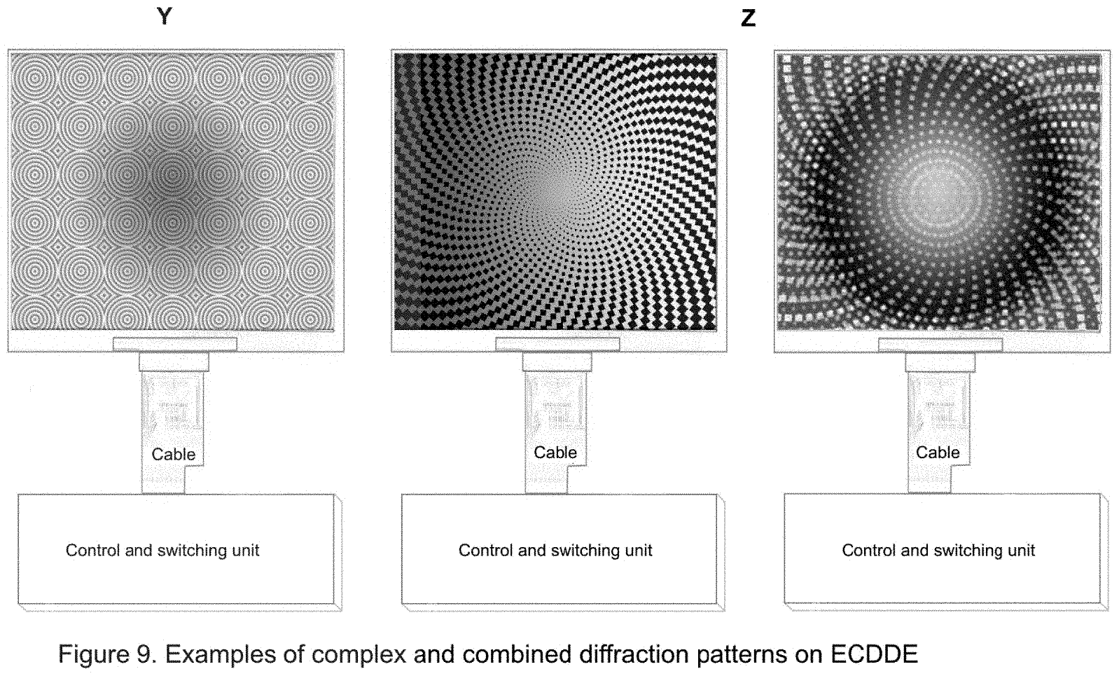

FIG. 9 illustrates implementation of very densely arranged multi-element (multi-indicator) ECDDEs, as an embodiment of the present invention.

### DETAILED DESCRIPTION OF INVENTION AND DRAWINGS

FIG. 1. An electronically controlled diffraction-diaphragming element (ECDDE) contains the housing of the device (1), which contains control unit on integrated circuit (2), contact system (3—contact loop) with a light-controlling (modeling) electronic element (4) (according to the text, a surface or plane may occur ECDDE), made with the possibility of partial or complete dimming, color change, as well as the creation of refraction and reflection on the specified areas of the element by electronic control. The control unit (2) may have manual, automatic or semi-automatic control based on received data from other technical devices, may contain a memory block for preset or manually set modes. The coupled system of the control unit (2) can be analog, digital, have discrete or remote mode switching, that is, it can be controlled by various types and types of signals. The size and shape of the light-controlling electronic element (4) varies when used by different optical equipment and different installation types. The ECDDE device of different sizes is designed for installation inside or outside of phones, cameras, video cameras, lenses, telescopes, instruments, as well as adapters connecting various optical devices and systems.

The light-controlling diffraction electronic element of the ECDDE (4) can be of various shapes, can consist of several control layers and have internal cavities or voids (5), can consist of segments, it is preferably using the shape of a rectangle (pos. A) or a circle (pos. B).

As this technology develops, it is planned to use spherical (pos. E), conical (pos. F), pyramidal (pos. D), ellipsoid and other three-dimensional forms of the light control element ECDDE (4). Such complex three-dimensional shapes will be able to better control the direction of movement, polarity and intensity of light rays (volumetric electronic diffraction diaphragming elements VEDDE).

These diffraction diaphragming elements of ECDDE are based on the technology of light control (modulation)—full or partial controlled dimming and refraction of light rays when constructing changeable stencil shapes and patterns on a transparent or reflective partition, which are described in the context of this patent solution. The light-guiding electronic element of the ECDDE (4) can be made using technologies such as liquid crystal elements and indicators (LCD), based on electrophoretic technology (electronic ink), microelectromechanical systems (Mems), digital micro-mirroring devices or changeable optical metamaterials, as well as other controlled indicator technologies. The main property of the light-controlling electronic element of the EDDE should be the possibility of modulation—control of light flows on micro and nano level, on the entire or selected area of the device (ECDDE). For ECDDE, it is preferable to use available and common LCD elements. In mirror lenses and mirror optical devices, it is better to create such special effects apply elements based on reflection from the partition wall of ECDDE—micro-mirroring devices, MEMS and controlled electrophoresis technology.

FIG. 2. The ECDDE is installed in an optical system consisting of a photosensitive element (in the text—a Sensor), optical and mechanical elements of the lens (lenses). The sensor (6) of the optical system can be made both in the form of a photosensitive chemical layer (photographic film) and in the form of a photosensitive matrix of an analog or digital device, and can also be made in other ways, and is not the subject of descriptions of this patent solution.
Internal installation (I) of an electronically controlled diffraction-diaphragm element may be more preferable—the embedding of an ECDDE (4.a) into the lens or apparatus next to or instead of the main diaphragm or shutter device, lens or optical device. Thus, the ECDDE performs the function of the main or auxiliary diaphragm, that is, it is an electronic diffraction diaphragm (EDD) and can control the aperture of an optical device. With such an installation, the ECDDE can additionally adjust the optical system and change the characteristics of the resulting image (sharpness, brightness, contrast, color, aberration, focus, etc.).
External installation (II) is carried out outside the lens, camera. Installation is carried out using an adapter for the thread of a light filter or a rectangular insert (4.b), in this way the ECDDE performs the role of a light filtering and regulating the luminous flux of the device in front of the main (receiving) lens. Thus, it is possible to carry out brightness-contrast, color, diopter, aberration and other types of optical correction of the front lens of the device or apparatus, respectively, and the entire existing optical system.
Intermediate installation in the adapter (III) between the lens and the device (sensor). In this case, reciprocal mounting systems are used for different types of hardware bayonets. The ECDDE element is located in the binding adapter (4.c), can be an adapter for various optical devices and systems. It can also be installed directly next to a photosensitive element (Sensor). In this way, you can change and adjust the properties of the existing optical system (sharpness, brightness, contrast, color, aberration, focus).
Installation in SLR lenses (IV), reflex telescopes and systems where ECDDE can be electronically-controlled diffraction diaphragm mirror (4.d), and replaces one of the reflecting mirrors (can be made on the basis of mEMS, digital micro-mirroring devices or on the basis of electrophoretic liquid ink technology). In addition to the previously listed adjustment functions, such an installation will be able to adjust the image (distant or close objects) in real time when using additional data for correction.

BEST MODE In the context of this patent, the basic principles of the device operation are described and examples of creating special effects are shown. These tasks are solved by an electronically controlled diffraction-diaphragm element (ECDDE) and combined systems based on them. A system based on ECDDE can have more settings and preset parameters, form various variations of the shown types of stencil patterns, images on its surface and create other types of work. The device with these parameters is ready for trial and it has the expediency for practical pilot-industrial application for the development of its functionality in the consumer sector of optical devices. It is of interest primarily for photographers, amateur photographers, video and cinematographers, projectionists, astronomers and users of laser, holographic and other optical devices.

### SOME EXAMPLES OF USING DEVICES WITH ECDDE

1. Depending on the type of installation, the ECDDA can be an electronically diffraction diaphragm and perform the function of the main or additional aperture diaphragm, can change the aperture value of an optical device or lens, and also perform the function of a field diaphragm (the aperture of the field of view). At the same time, the ECDDE element can also perform brightness-contrast, diopter, aberration and other types of optical correction of the front lens of the device, can be an adapter for different optical devices and systems, replace one of the reflecting mirrors (FIG. 2) or lenses. The ECDDE element can be installed in an optical device or lens or apparatus next to or instead of the main diaphragm or shutter device; or installed outside the lens, optical device or camera; or installed between the optical device or lens and the apparatus or sensor; or replace one of the reflecting mirrors in mirror lenses, reflex telescopes and systems. It can also be installed directly in the device next to the Sensor.

2. Using the surface of the ECDDE element to form a correction stencil in all modes of operation of the device. The correcting stencil pattern (template pattern) can be gradient, radial, complex-differentiated, abstract and of a predetermined preset shape. The function of gradient and corrective mode of operation is necessary to equalize the intensity of the collected light flux on the sensor, correction aberrations, sharpness zones and vignetting of various optical devices, as well as brightness and contrast correction, color and tone replacement of the entire image or its selected part, expansion of the dynamic range of the resulting image (FIG. 3).

3. Using the ECDDE device as an electronically controlled aperture of various stencil shapes. The aperture can be changed in all main and additional modes. There can be different shapes in the transparency zone. Different shapes of the diaphragm (transparent stencil shapes) give different special image effects (flares) in the defocusing zone, similar in shape to the contour of the aperture figure. Both instantaneous switching of shapes (aperture transparency figures) and smooth or stepwise (dynamic, stepwise, preset, etc. operating modes) are provided (FIG. 4 and FIG. 5).

4. An example of using combined ECDDE functions to form a multi-aperture (several stencils of diaphragms on one ECDDE). Creation of several separately controlled transparency zones to adjust the luminous flux in several directions. An ECDDE with a multi-aperture (multi-axis) aperture shape can be used with one lens on several sensors or be one connecting electronic diaphragm for several lenses and sensors (pos. Jx FIG. 4).

5. An example of using combined ECDDE functions in all modes of operation.

Uneven opening of the diaphragm together with the formation of additional stencil shapes on the plane to correct sharpness and other characteristics that normalize the image and do not change the shape of flares in the area of blurring (the shape of contours in the area of defocusing) (Example FIG. 6 pos. O and pos. P).

6. As described earlier, it is possible to open and close the ECDDE element as an electronically controlled diffraction diaphragm in different directions, with the creation of different shapes of unshaded areas in different areas of the light-controlling element (for example, FIG. 6 pos. M and pos. N). With smooth transitions of stencil shapes on the ECDDE you can create dynamic special effects of the depicted space on the photosensitive element, leaving the overall illumination and sharpness in the specified or programmed ranges, but with a change in the contours of the flares.

7. Using ECDDE as artistic filters to create radial linear, ring-shaped, radial, spiral and other stencil lines. A special effect is obtained on the sensor due to refraction and reflection of rays on the ECDDE plane. When the interval, thickness, shape and location of the lines change, the artistic effect of point light sources changes. The use of the effect is possible mainly in dynamic, artistic, preset and combined modes of operation. There is a possibility dynamic change of the effect, for example, creating the visibility of the rotation of stencil lines on the ECDDE, which will create a special effect on the sensor of the device (FIG. 7).

8. Using ECDDE as artistic light filters in the main in dynamic, artistic, preset and combined modes of operation to create special defocusing (blurring) effects, creating areas of blurring or halos of glow contours of the whole or part of the image on the sensor (FIG. 8). Due to the formation of diffusion, diffraction and combined complex interference light-forming stencils.

9. When using very densely arranged multi-element (multi-indicator) ECDDEs, it is possible to reproduce combined and complex interference stencils that change the focus of the entire optical system or its selected part, which allows you to adjust the sharpness zone, change the focal length of the optical device. Increase or decrease the overall and contour sharpness of the resulting image on the sensor, change the focal length of the optical device (FIG. 9).

1. An electronically controlled diffraction-diaphragming element (ECDDE) contains a device housing in which there is a control unit on an integrated circuit, a contact system with a light-controlling electronic element, made with the possibility of partial or complete dimming, color change, as well as the creation of refraction and reflection on specified areas of the element, by means of electronic control.

2. An electronically controlled diffraction-diaphragm element (ECDDE) according to claim 1, can be used as an electronic diffraction diaphragm (EDD) and have various methods of installation inside or outside optical devices or apparatuses.

3. An electronically controlled diffraction-diaphragming element (ECDDE) according to claim 1, where a light-controlling element can be installed inside an existing or new optical device next to or instead of an existing diaphragming element.

4. An electronically controlled diffraction-diaphragming element (EDDE) according to claim 1, where a light-controlling element can be installed inside an existing or new optical device next to or instead of an existing aperture.

5. Electronically controlled diffraction-diaphragming the element (ECDDE) according to claim 1, where the light-controlling element can be installed outside an existing or new optical device next to or instead of the existing optical filter of the optical device.

6. Electronically controlled diffraction-diaphragming element (ECDDE) according to claim 1, where the light-controlling element can be installed outside the existing or new lens next to or instead of the existing lens filter.

7. An electronically controlled diffraction-diaphragming element (ECDDE) according to claim 1, where a light-controlling element can be installed between the device and an optical device instead of the existing connecting adapter of the optical system.

8. Electronically controlled diffraction-diaphragming element (ECDDE) according to claim 1, where the light-controlling element can be installed between the photosensitive element (according to the text Sensor) and a lens instead of the existing connecting adapter of the optical system (sensor and lens).

9. An electronically controlled diffraction-diaphragming element (ECDDE) according to claim 2, characterized in that the light-controlling element can be made in a two-dimensional form in the form of a flat partition, which has an arbitrary appearance and may contain free cavities.

10. An electronically controlled diffraction-diaphragming element (ECDDE) according to claim 2 characterized in that the light-controlling element can be made in three-dimensional form, in the form of a partition of arbitrary volumetric shape and may contain free cavities (voids).

11. Electronically controlled diffraction-diaphragming element (ECDDE) according to claim 9 characterized in that the control unit has manual control based on the received data from other technical devices, preset or manually set modes.

12. Electronically controlled diffraction-diaphragming element (ECDDE) according to claim 9 characterized in that the control unit has automatic control based on the received data from other technical devices, preset or manually set modes.

13. Electronically controlled diffraction-diaphragming element (ECDDE) according claim 9 characterized in that the control unit has semi-automatic control based on received data from other technical devices, preset or manually set modes.

14. Electronically controlled diffraction-diaphragm element (ECDDE) according to claim 11 characterized in that it has an analog control system based on received data from other technical devices, preset or manually set modes.

15. Electronically controlled diffraction-diaphragm element (ECDDE) according claim 11 characterized in that it has a digital control system based on received data from other technical devices, preset or manually set modes.

16. Electronically controlled diffraction-diaphragming element (ECDDE) according claim 14 characterized in that it has several main types of operating modes in the control unit dynamic, artistic, preset (based on presets), stepwise, gradient, corrective, focusing mode and in each of the main types of modes jobs can be integrated into sub-modes of work.

17. Electronically controlled diffraction-diaphragming element (ECDDE) according to claim 16, characterized in that the specified operating mode is set based on presets.

18. Electronically controlled diffraction-diaphragming element (ECDDE) according to claim 16, characterized in that it has combined modes of operation based on the main types of operating modes and additionally set operating modes.
